(19) United States
(12) Patent Application Publication
(10) Pub. No.: US 2025/0235927 A1
(43) Pub. Date: Jul. 24, 2025

(54) FERRITE MOLDING PROCESS, FERRITE MOLDING MOLD, AND FERRITE

(71) Applicant: Lanto Electronic Limited, Kunshan City (CN)

(72) Inventors: Quangen ZHU, Kunshan City (CN); Ziqiang WU, Kunshan City (CN); Chen CHEN, Kunshan City (CN); Ruolan LI, Kunshan City (CN)

(73) Assignee: Lanto Electronic Limited, Kunshan City (CN)

(21) Appl. No.: 18/676,729

(22) Filed: May 29, 2024

(30) Foreign Application Priority Data
Jan. 22, 2024 (CN) 202410087162.7

(51) Int. Cl. B22F 3/16; B22F 3/24; B22F 5/10

(52) U.S. Cl. CPC B22F 3/162; B22F 3/24; B22F 5/10; B22F 2003/247; B22F 2302/25

(57) ABSTRACT

Provided are a ferrite molding process, a ferrite molding mold, and a ferrite, which belong to the field of ferrite preparation technologies. The ferrite molding process includes the following steps: adding a powder to a molding mold, where the molding mold is provided with a gap forming structure, and the gap forming structure is used for forming a gap of a ferrite; compressing the powder into a blank; sintering the blank in a heating furnace to form a sintered blank; and performing molding on the sintered blank to obtain a ferrite. The ferrite molding mold includes a main molding mold, and the main molding mold is provided with a molding cavity for molding a blank and a gap forming structure for forming a gap of a ferrite.

### CROSS-REFERENCE TO RELATED APPLICATION(S)

This application claims priority to Chinese Patent Application No. 202410087162.7 filed Jan. 22, 2024, the disclosure of which is incorporated herein by reference in its entirety.

### TECHNICAL FIELD

The present disclosure relates to the field of ferrite preparation technologies and, in particular, to a ferrite molding process, a ferrite molding mold, and a ferrite.

### BACKGROUND

With the development of wireless charging technology, wireless charging has been rapidly popularized in smart electronic products. A wireless charging module generally adopts a soft magnetic material to form a shielding assembly, and an example of the soft magnetic material is the ferrite. The ferrite generally includes a main body and a boss disposed on the main body, and a coil is wound on the boss for enhancing a magnetic gathering capability of the ferrite. The main body is provided with a gap for securing the end of the coil.

In the related art, the manufacturing process of the ferrite includes the steps of compressing, sintering, grinding, gap forming, and tumble finishing. Specifically, during the compressing, a material powder for forming the ferrite is added to a mold, high pressure is applied for compression molding, and the commonly used molding methods include dry pressing and slip casting. During the sintering, the molded part is sintered in a high-temperature furnace, and under high temperature, the powder particles are bonded to each other to form a dense crystal structure. During the gap forming, the sintered part is processed by mechanical equipment, such as cutting. During the tumble finishing, the part obtained after gap forming and a grinding medium rotate in a barrel at a low speed to perform polishing by means of the relative movement of the part and the grinding material. However, in the manufacturing process, the gap forming will lead to the breakage of the part, the manner adopted for gap forming will also make the part become extremely fragile, and then after the tumble finishing, the yield of the entire ferrite manufacturing process is only about 60%. Moreover, some parts with potential microcracks may be used in the assembly stage, and after coil assembly and pressure maintaining, the loss of yield of 5% or below will be caused, thereby resulting in a low yield of the ferrite manufacturing process.

### SUMMARY

The object of the present disclosure is to provide a ferrite molding process, a ferrite molding mold, and a ferrite, and the ferrite manufactured herein has a high yield.

As conceived above, the schemes adopted by the present disclosure are as below.

A ferrite molding process is provided. The ferrite molding process includes steps S1, S2, S3, and S4.

In S1, a powder is added to a molding mold, where the molding mold is provided with a gap forming structure, and the gap forming structure is used for forming a gap of a ferrite.

In S2, the powder is compressed into a blank.

In S3, the blank is sintered in a heating furnace to form a sintered blank.

In S4, molding is performed on the sintered blank to obtain the ferrite.

Optionally, the ferrite includes a body structure and a boss structure, and the body structure and the boss structure are integrally formed in one mold.

Optionally, the ferrite includes a body structure and a boss structure, and the body structure and the boss structure are formed separately in two molds.

Optionally, in step S1, the powder is added to a body mold and a boss mold, where the body mold includes the gap forming structure.

In step S2, a body blank is formed by compressing in the body mold, and a boss blank is formed by compressing in the boss mold.

In step S3, the body blank is sintered in the heating furnace to form a sintered body blank, and the boss blank is sintered in the heating furnace to form a sintered boss blank.

The sintered body blank includes a first residue and the body structure which are integrated, the body structure has a gap, and the sintered boss blank includes a second residue and the boss structure which are integrated. Step S4 includes steps S41, S42, and S43.

In S41, the first residue of the sintered body blank is removed to obtain the body structure.

In S42, the second residue of the sintered boss blank is removed to obtain the boss structure.

In S43, the boss structure and the body structure are connected to obtain the ferrite.

Optionally, in step S41, the first residue of the sintered body blank is removed by grinding to obtain the body structure.

In step S42, the second residue of the sintered boss blank is removed by grinding to obtain the boss structure.

Optionally, the step S43 includes steps S431 and S432.

In S431, the body structure is coated with an adhesive.

In S432, the boss structure is pressed onto the adhesive to bond the boss structure to the body structure through the adhesive.

Optionally, the first residue is in a ring shape, the body structure is in an open ring shape, the inner ring surface of the first residue is flush with the inner ring surface of the body structure, and the width of the first residue is greater than the width of the body structure.

Optionally, before step S43, the ferrite molding process further includes the following steps.

Tumble finishing is performed on the body structure.

Tumble finishing is performed on the boss structure.

Optionally, the sintered blank includes a top residue, a body structure, a boss structure, and a bottom residue which are integrated, and in step S4, the top residue and the bottom residue are removed by grinding to obtain the ferrite.

A ferrite molding mold is provided. The ferrite molding mold is applied to the ferrite molding process described above and includes a main molding mold. The main molding mold is provided with a molding cavity for molding a blank and a gap forming structure for forming a gap of a ferrite.

Optionally, the sintered blank includes a top residue, a body structure, a boss structure, and a bottom residue which are integrated. The main molding mold includes a lower punch, a mold core, and an upper punch. The end surface of one end of the lower punch is provided with a first molding groove. The groove bottom of the first molding groove is provided with a second molding groove. The groove bottom of the second molding groove is provided with a core bore. The mold core passes through the core bore, the first molding groove, and the second molding groove.

The gap forming structure includes a first protrusion disposed on the groove sidewall of the first molding groove and a second protrusion disposed on the groove bottom wall of the first molding groove. The bottom end of the upper punch is provided with a third protrusion that can extend into the first molding groove and that is disposed opposite to the first protrusion. The molding cavity includes a top molding cavity formed by the first protrusion, the second protrusion, the groove sidewall of the first molding groove and the mold core and a bottom molding cavity formed by the groove sidewall of the second molding groove and the mold core. The top molding cavity is used for molding the top residue and the body structure. The bottom molding cavity is used for molding the boss structure and the bottom residue.

Optionally, two fourth protrusions are disposed on two ends of the top surface of the second protrusion, respectively, and the height sum of the fourth protrusion and the second protrusion is equal to the thickness of the body structure.

Optionally, the main molding mold includes a body mold and a boss mold.

The body mold includes a first lower stamping, a first mold core, and a first upper stamping. The end surface of one end of the first lower stamping is provided with a first groove. The groove bottom of the first groove is provided with a second groove. The groove bottom of the second groove is provided with a first through hole extending to the end surface of the other end of the first lower stamping. The first mold core is inserted through the first through hole, the first groove, and the second groove. The first mold core and the groove sidewall of the first groove form a first molding cavity for molding a first residue. The first mold core and the groove sidewall of the second groove form a second molding cavity for molding the body structure. The gap forming structure is a protruding block disposed in the second molding cavity. The first upper stamping is used for applying pressure on a powder in the first molding cavity and a powder in the second molding cavity to mold a body blank by compressing.

The boss mold includes a second lower stamping, a second mold core, and a second upper stamping. The end surface of one end of the second lower stamping is provided with a third groove. The groove bottom of the third groove is provided with a fourth groove. The groove bottom of the fourth groove is provided with a second through hole extending to the end surface of the other end of the second lower stamping. The second mold core is inserted through the second through hole, the third groove, and the fourth groove. The second mold core and the groove sidewall of the third groove form a third molding cavity for molding a second residue. The second mold core and the groove sidewall of the fourth groove form a fourth molding cavity for molding the boss structure. The second upper stamping is used for applying pressure to a powder in the third molding cavity and a powder in the fourth molding cavity to mold a boss blank by compressing.

A ferrite is provided. The ferrite is manufactured by using the ferrite molding process described above.

The beneficial effects of the present disclosure are as below.

In the ferrite molding process, the ferrite molding mold, and the ferrite provided by the present disclosure, a powder is first added to a molding mold, the powder is compressed into a blank, the blank is sintered in a heating furnace to form a sintered blank, and molding is directly performed on the sintered blank to obtain the ferrite. Since the molding mold in the present disclosure is provided with a gap forming structure, no gap forming step needs to be performed after sintering, thereby simplifying the process flow of the ferrite and cutting the investment in gap forming equipment; the occurrence of breakage of the sintered blank in the gap forming step is prevented to make the sintered blank structurally stronger so that the risk of breakage of the ferrite in the assembling stage is reduced, thereby improving the yield of the ferrite.

### BRIEF DESCRIPTION OF DRAWINGS

FIG. 1 is a flowchart of a ferrite molding process according to an embodiment of the present disclosure;

FIG. 2 is a structure view one of a blank according to an embodiment of the present disclosure;

FIG. 3 is a structure view two of a blank according to an embodiment of the present disclosure;

FIG. 4 is a structure view one of a main molding mold according to an embodiment of the present disclosure;

FIG. 5 is a structure view two of a main molding mold according to an embodiment of the present disclosure;

FIG. 6 is an enlarged view of part A of FIG. 5 of the present disclosure;

FIG. 7 is a reference view showing a usage state of a main molding mold according to an embodiment of the present disclosure;

FIG. 8 is a structure view of an upper punch according to an embodiment of the present disclosure;

FIG. 9 is a structure view of a boss structure and a second residue according to an embodiment of the present disclosure;

FIG. 10 is a structure view of a body structure and a first residue according to an embodiment of the present disclosure;

FIG. 11 is an exploded view of a body structure and a boss structure according to an embodiment of the present disclosure;

FIG. 12 is a structure view of a ferrite according to an embodiment of the present disclosure;

FIG. 13 is an exploded view of a body mold according to an embodiment of the present disclosure;

FIG. 14 is a structure view of a first lower stamping according to an embodiment of the present disclosure; and

FIG. 15 is an exploded view of a boss mold according to an embodiment of the present disclosure.

In the drawings:
100. ferrite; 110. body structure; 120. boss structure; 200. sintered blank; 210. top residue; 220. spacing; 230. material aperture; 300. first residue; 400. second residue;
510. lower punch; 511. first molding groove; 512. second molding groove; 513. core bore; 514. first protrusion; 515. second protrusion; 516. third protrusion; 517. fourth protrusion; 520. mold core; 530. upper punch;
600. body mold; 610. first lower stamping; 611. first groove; 612. second groove; 613. first through hole; 614. protruding block; 620. first mold core; 630. first upper stamping;
700. boss mold; 710. second lower stamping; 711. third groove; 712. fourth groove; 720. second mold core; 730. second upper stamping.

### DETAILED DESCRIPTION

To make problems to be solved, adopted schemes and achieved effects of the present disclosure clearer, schemes of the present disclosure are further described below through embodiments in conjunction with drawings. It is to be understood that the embodiments described herein are intended to explain the present disclosure and not to limit the present disclosure. In addition, it is to be noted that for ease of description, only a part, not all, related to the present disclosure is illustrated in the drawings.

It is to be noted that similar reference numerals and letters indicate similar items in subsequent drawings. Therefore, once a certain item is defined in one drawing, the similar reference numeral or letter does not need to be defined or explained in the subsequent drawings.

In the description of the present disclosure, unless otherwise expressly specified and limited, the term “connected to each other”, “connected” or “secured” is to be construed in a broad sense, for example, as securely connected, detachably connected or integrated; mechanically connected or electrically connected; directly connected to each other or indirectly connected to each other via an intermediary; or internally connected between two components or interaction relations between two components. For those of ordinary skill in the art, specific meanings of the preceding terms in the present disclosure may be construed based on specific situations.

In the present disclosure, unless otherwise expressly specified and limited, when a first feature is described as “on” or “below” a second feature, the first feature and the second feature may be in direct contact or may be in contact via another feature between the two features instead of being in direct contact. Moreover, when the first feature is described as “on”, “above”, or “over” the second feature, the first feature is right on, above, or over the second feature, the first feature is obliquely on, above, or over the second feature, or the first feature is simply at a higher level than the second feature. When the first feature is described as “under”, “below”, or “underneath” the second feature, the first feature is right under, below, or underneath the second feature, the first feature is obliquely under, below, or underneath the second feature, or the first feature is simply at a lower level than the second feature. In the description of the embodiments, unless otherwise specified, “a plurality of” or “multiple” means two or more.

In the description of this embodiment, orientations or position relations indicated by terms such as “upper”, “lower” and “right” are based on the drawings. These orientations or position relations are intended only to facilitate and simplify the description and not to indicate or imply that a device or element referred to must have such particular orientations or must be configured or operated in such particular orientations. Thus, these orientations or position relations are not to be construed as limiting the present disclosure. In addition, the terms “first” and “second” are used only for distinguishing descriptively and have no special meanings.

### Embodiment One

This embodiment provides a ferrite molding process for molding a ferrite, and the ferrite prepared herein has a high yield.

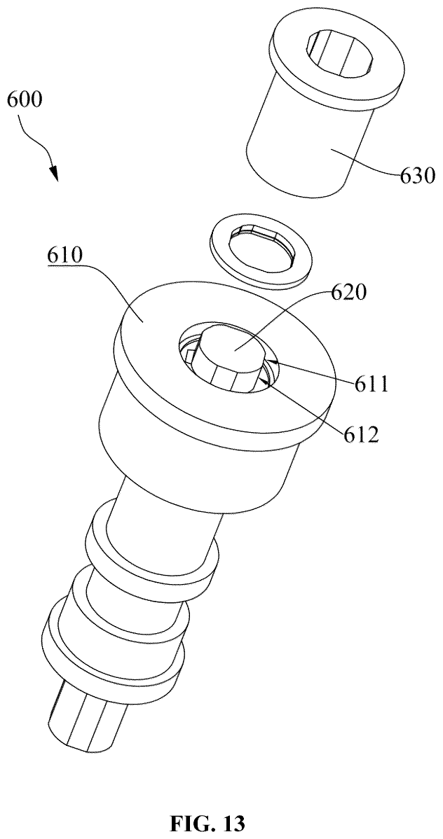

It is to be noted that, as shown in FIG. 12, the ferrite 100 in this embodiment includes a body structure 110 and a boss structure 120. Both the body structure 110 and the boss structure 120 are in a ring shape, and the boss structure 120 is disposed on the surface of the body structure 110 and is coaxial with the body structure 110. The boss structure 120 is used for winding a coil, and the body structure 110 is provided with a gap to facilitate the setting of the end of the coil. In some embodiments, the gap is obtained by opening an opening on the body structure 110, that is, the body structure 110 is in the shape of a ring with an opening.

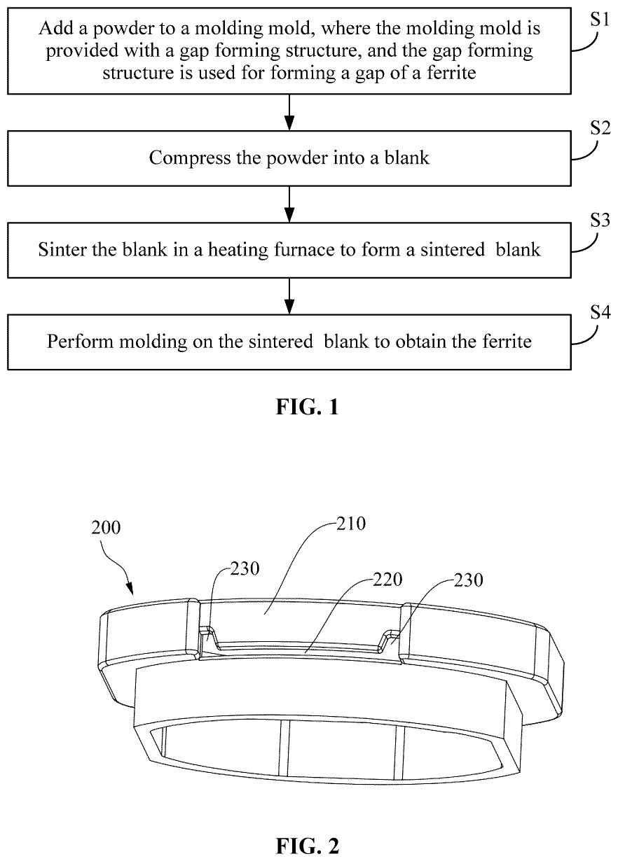

As shown in FIG. 1, the ferrite molding process includes steps S1, S2, S3, and S4.

In S1, a powder is added to a molding mold, where the molding mold is provided with a gap forming structure, and the gap forming structure is used for forming a gap of a ferrite 100.

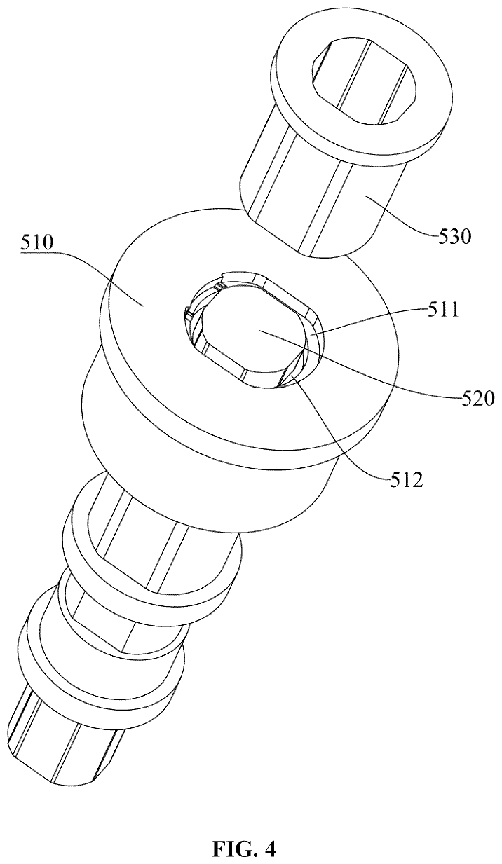

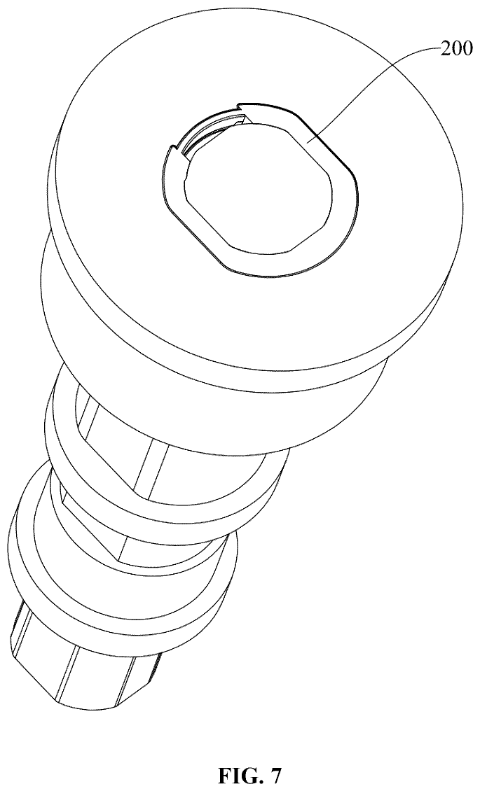

In this embodiment, the molding mold is directly provided with the gap forming structure for forming the gap, and there is no need to subsequently perform secondary processing to generate a gap. The molding mold in this embodiment may have a structure shown in FIGS. 4 to 8. In some embodiments, the gap forming structure may be a protruding structure to form a gap or may be another structure, which is not limited in this embodiment. For the method of adding the powder to the molding mold, reference may be made to the related art, which is not described in detail in this embodiment.

In S2, the powder is compressed into a blank.

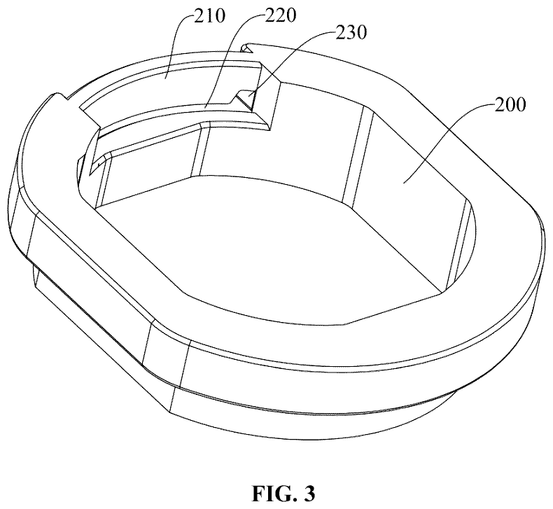

After the powder is added to the molding mold, the powder is compressed to mold the powder. FIGS. 2 and 3 are views of a blank or a sintered blank 200 according to embodiments of the present disclosure. It is to be noted that the shape and size of the blank are different from the shape and size of the to-be-prepared ferrite 100, that is, the blank has residual materials. For the method of compressing the powder, reference may be made to the related art, which is not described in detail in this embodiment.

In S3, the blank is sintered in a heating furnace to form a sintered blank 200.

For the method of heating the blank in a heating furnace in step S3, reference may be made to the related art, which is not described in detail in this embodiment.

It is to be noted that the shape and size of the sintered blank 200 are the same as the shape and size of the blank.

In S4, molding is performed on the sintered blank 200 to obtain the ferrite 100.

In this embodiment, since the blank is an object that includes residual materials, when a ferrite 100 is to be prepared, molding needs to be performed on the blank. For example, the molding may include grinding or other residual material removing manners, which is not limited in this embodiment.

In the ferrite molding process provided by this embodiment, a powder is first added to a molding mold, the powder is compressed into a blank, the blank is sintered in a heating furnace to form a sintered blank 200, and molding is directly performed on the sintered blank 200 to obtain the ferrite 100. Since the molding mold in this embodiment is provided with a gap forming structure, no gap forming step needs to be performed after sintering, thereby simplifying the process flow of the ferrite 100 and cutting the investment in gap forming equipment; the occurrence of breakage of the sintered blank 200 in the gap forming step is prevented to make the sintered blank 200 structurally stronger so that the risk of breakage of the ferrite 100 in the assembling stage is reduced, thereby improving the yield of the ferrite 100.

In some embodiments, the body structure 110 and the boss structure 120 are integrally formed in one mold.

Optionally, as shown in FIGS. 2 and 3, the sintered blank 200 includes a top residue 210, a body structure 110, a boss structure 120, and a bottom residue which are integrated. In step S4, the top residue 210 and the bottom residue are removed by grinding to obtain the ferrite shown in FIG. 12.

This embodiment further provides a ferrite molding mold applied to the ferrite molding process described above. Specifically, the ferrite molding mold includes a main molding mold. The main molding mold is provided with a molding cavity for molding a blank and a gap forming structure for forming a gap of a ferrite 100.

Further, as shown in FIGS. 4 to 8, the main molding mold includes a lower punch 510, a mold core 520, and an upper punch 530. The end surface of one end of the lower punch 510 is provided with a first molding groove 511. The groove bottom of the first molding groove 511 is provided with a second molding groove 512. The groove bottom of the second molding groove 512 is provided with a core bore 513. The mold core 520 passes through the core bore 513, the first molding groove 511, and the second molding groove 512. Specifically, the bottom end of the mold core 520 is located outside the core bore 513, and the bottom end of the mold core 520 is located in the first molding groove 511.

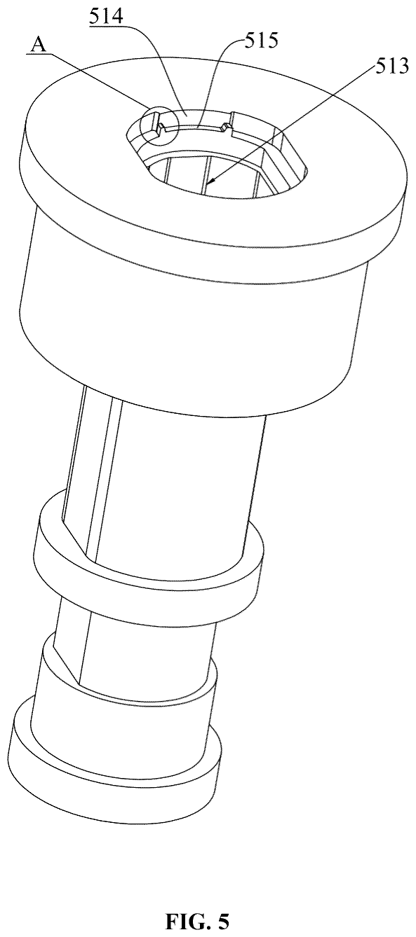

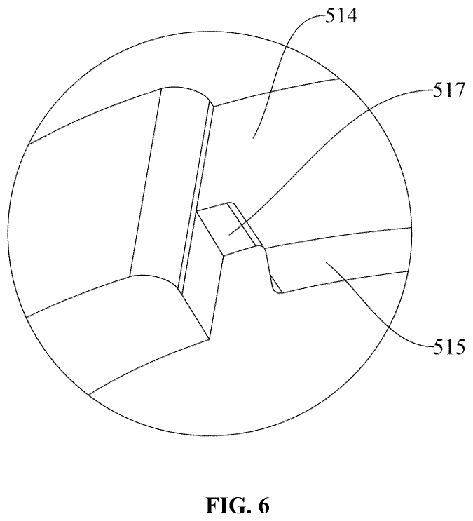

As shown in FIGS. 5 and 6, the gap forming structure in this embodiment includes a first protrusion 514 disposed on the groove sidewall of the first molding groove 511 and a second protrusion 515 disposed on the groove bottom wall of the first molding groove 511, that is, the first protrusion 514 and the second protrusion 515 can cooperate to form the gap. In this embodiment, the first protrusion 514 is connected to the second protrusion 515. In some embodiments, the length of the second protrusion 515 is the same as the length of the first protrusion 514. The second protrusion 515 is used for forming a spacing 220 between the top residue 210 and the boss structure 120, and the spacing 220 is a part of the gap. The setting of the spacing 220 allows the top residue 210 to be not directly connected to the boss structure 120 so that the top residue 210 can be smoothly removed without affecting the boss structure 120.

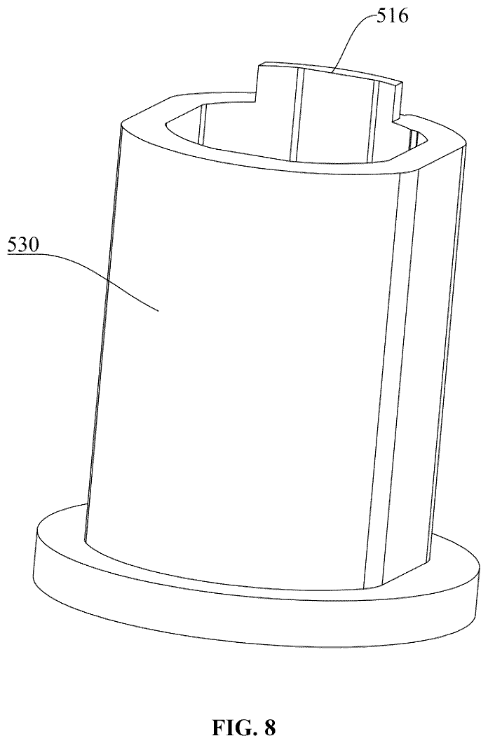

Optionally, as shown in FIG. 8, the bottom end of the upper punch 530 is provided with a third protrusion 516 that can extend into the first molding groove 511 and that is disposed opposite to the first protrusion 514. The molding cavity includes a top molding cavity enclosed by the first protrusion 514, the second protrusion 515, the groove sidewall of the first molding groove 511 and the mold core 520 and a bottom molding cavity enclosed by the groove sidewall of the second molding groove 512 and the mold core 520. The top molding cavity is used for molding the top residue 210 and the body structure 110, and the bottom molding cavity is used for molding the boss structure 120 and the bottom residue. It is to be noted that the top residue 210 is in a ring shape, and the thickness of a portion of the top residue 210 facing the gap is less than the thickness of any other portion of the top residue 210. Specifically, the first protrusion 514 cooperates with the third protrusion 516 to form the portion of the top residue 210 facing the gap, and the portion is relatively thin. In this manner, in one aspect, the removal of the top residue 210 is facilitated, and in another aspect, the direct contact and pressing of the boss structure 120 by the third protrusion 516, thereby further ensuring the molding quality of the boss structure 120.

Further, as shown in FIG. 6, two fourth protrusion portions 517 are disposed on two ends of the top surface of the second protrusion portion 515, respectively, and the first protrusion 514 is used for forming the material aperture 230 shown in FIG. 2. The height sum of the fourth protrusion 517 and the second protrusion 515 is equal to the thickness of the body structure 110 so that during grinding, the body structure 110 may be obtained by only grinding the portion of the top residue 210 above the material aperture 230. The setting of the material aperture 230 enables the thickness of the body structure 110 to meet the requirements.

In some embodiments, the top surface of the top residue 210 is flush with the top surface of the upper punch 530 or the top surface of the top residue 210 is lower than the top surface of the upper punch 530 so that the upper punch 530 can extend into the first molding groove 511 to better compress the powder.

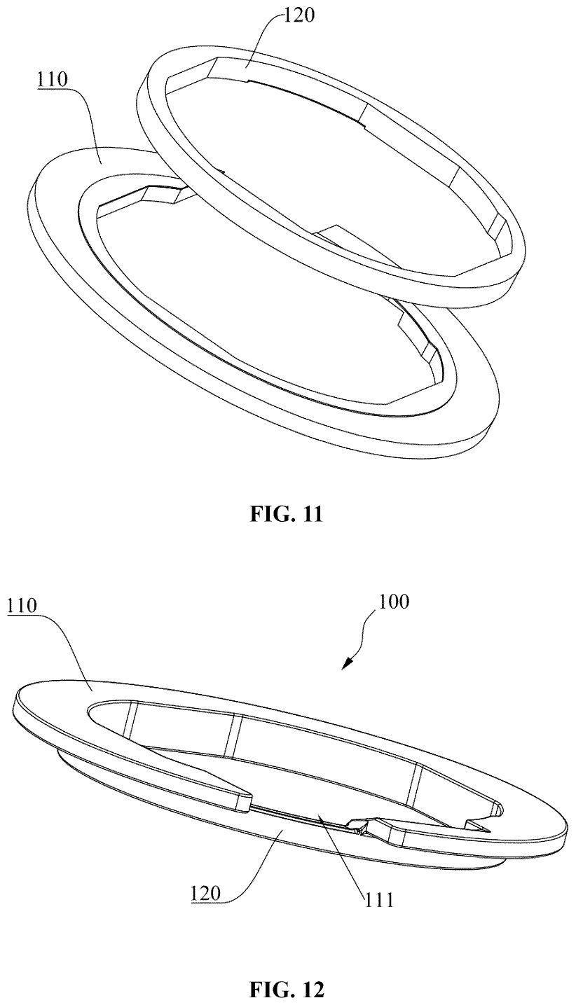

In the ferrite molding process provided by this embodiment, the body structure 110 and the boss structure 120 are integrally formed, as shown in FIGS. 2 and 3, and the top residue 210 on one side of the body structure 110 away from the boss structure 120 and the bottom residue 210 on the side of the boss structure 120 away from the body structure 110 are also formed at the same time. Then, the top residue 210 and the bottom residue are removed by grinding to obtain the ferrite 100 with a gap shown in FIG. 11.

Optionally, in this embodiment, after the top residue 210 and the bottom residue are removed by grinding, tumble finishing may be performed on the body structure 110 and the boss structure 120. Since the body structure 110 and the boss structure 120 are not machined by mechanical cutting or puncturing, both the body structure 110 and the boss structure 120 have a relatively high structural strength. Therefore, the body structure 110 and the boss structure 120 are not prone to break during tumble finishing and have a relatively high yield.

### Embodiment Two

The difference between the ferrite molding process provided by this embodiment and the ferrite molding process in Embodiment one lies in that the body structure 110 and the boss structure 120 are formed separately in two molds, and the main molding mold in this embodiment is also different from the main molding mold in Embodiment one.

The ferrite molding process includes steps S1, S2, S3, and S4.

In S1, a powder is added to a molding mold, where the molding mold is provided with a gap forming structure, and the gap forming structure is used for forming a gap of a ferrite 100.

In S2, the powder is compressed into a blank.

In S3, the blank is sintered in a heating furnace to form a sintered blank 200.

In S4, molding is performed on the sintered blank 200 to obtain the ferrite 100.

In step S1, the powder is added to a body mold 600 and a boss mold 700, and the body mold 600 includes the gap forming structure.

In step S2, a body blank is formed by compressing in the body mold 600, and a boss blank is formed by compressing in the boss mold 700.

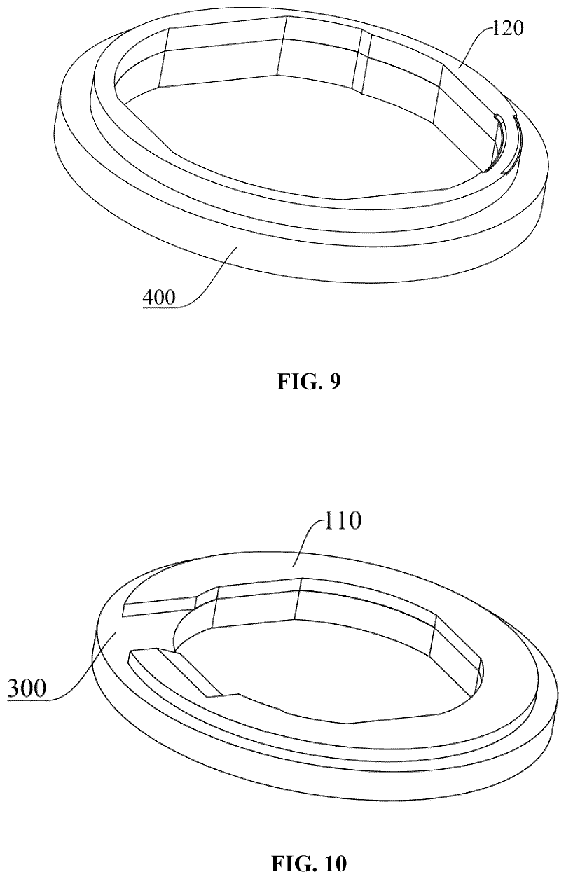

In step S3, the body blank is sintered in the heating furnace to form a sintered body blank, and the boss blank is sintered in the heating furnace to form a sintered boss blank. The structure of the sintered body blank is shown in FIG. 10, and the structure of the sintered boss blank is shown in FIG. 9.

The sintered body blank includes a first residue 300 and the body structure 110 which are integrated, the body structure 110 has a gap, and the sintered boss blank includes a second residue 400 and the boss structure 120 which are integrated. Step S4 includes steps S41, S42, and S43.

In S41, the first residue 300 of the sintered body blank is removed to obtain the body structure 110.

The body structure 110 obtained by removing the first residue 300 from the sintered body blank is shown in FIG. 11. As can be seen from FIG. 11, the body structure 110 has already had a gap.

In S42, the second residue 400 of the sintered boss blank is removed to obtain the boss structure 120.

The boss structure 120 obtained by removing the second residue 400 from the sintered boss blank is shown in FIG. 11. As can be seen from FIG. 11, the boss structure 120 is in a ring shape.

In S43, the boss structure 120 and the body structure 110 are connected to obtain the ferrite 100.

Optionally, in step S41, the first residue 300 of the sintered body blank is removed by grinding to obtain the body structure 110.

In step S42, the second residue 400 of the sintered boss blank is removed by grinding to obtain the boss structure 120.

Further, S43 includes steps S431 and S432.

In S431, the body structure 110 is coated with an adhesive.

In step S431, the adhesive is coated onto the region of the body structure 110 near the inner ring surface.

In S432, the boss structure 120 is pressed onto the adhesive to bond the boss structure 120 to the body structure 110 through the adhesive.

In this embodiment, the boss structure 120 and the body structure 110 are connected to each other through the adhesive, thereby improving the integrity of the ferrite 100.

In some embodiments, as shown in FIG. 10, the first residue 300 is in a ring shape, the body structure 110 is in an open ring shape, the inner ring surface of the first residue 300 is flush with the inner ring surface of the body structure 110, and the width of the first residue 300 is greater than the width of the body structure 110, thereby facilitating the forming the body structure 110 with a relatively complete structure and a relatively neat surface. Similarly, as shown in FIG. 9, both the second residue 400 and the boss structure 120 are in a ring shape, and the width of the second residue 400 is greater than the width of the boss structure 120, thereby facilitating the forming of the boss structure 120 with a relatively complete structure and a relatively neat surface.

Optionally, before the boss structure 120 and the body structure 110 are connected, that is, before step S43, the ferrite molding process further includes the following steps.

Tumble finishing is performed on the body structure 110.

Tumble finishing is performed on the boss structure 120.

In this embodiment, the body structure 110 and the boss structure 120 may be tumble finished in one barrel or the body structure 110 and the boss structure 120 may be tumble finished separately. Since the tumble finishing is performed before the boss structure 120 is connected to the body structure 110, the connection effect between the boss structure 120 and the body structure 110 is not affected, thereby improving the reliability of the connection between the body structure 110 and the boss structure 120.

For the ferrite molding process provided by this embodiment, a ferrite molding mold is provided. The ferrite molding mold includes a main molding mold. The main molding mold is provided with a molding cavity for molding a blank and a gap forming structure for forming a gap of a ferrite 100.

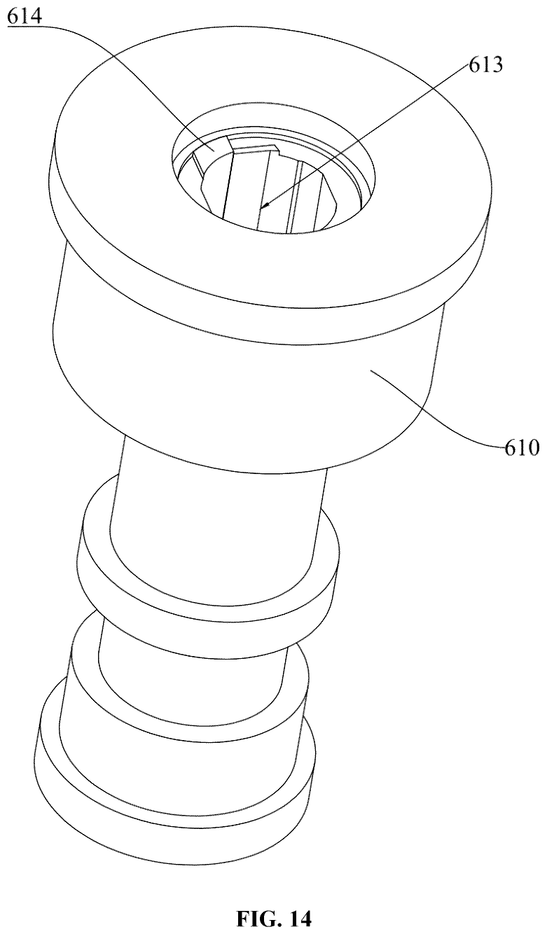

Further, as shown in FIGS. 13 to 15, the main molding mold includes a body mold 600 and a boss mold 700.

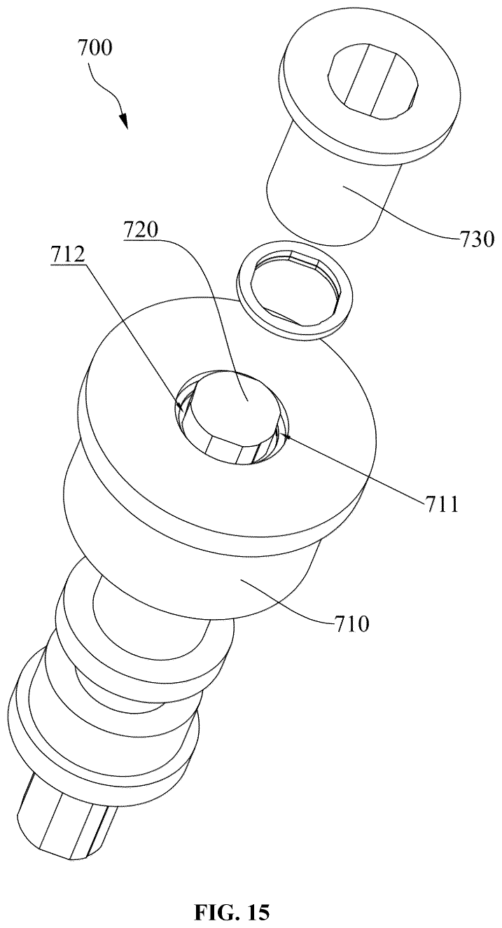

As shown in FIGS. 13 and 14, the body mold 600 includes a first lower stamping 610, a first mold core 620, and a first upper stamping 630. The end surface of one end of the first lower stamping 610 is provided with a first groove 611. Specifically, the end surface of the first lower stamping 610 facing the first upper stamping 630 is provided with a first groove 611. The groove bottom of the first groove 611 is provided with a second groove 612. The groove bottom of the second groove 612 is provided with a first through hole 613 extending to the end surface of the other end of the first lower stamping 610. The first mold core 620 is inserted through the first through hole 613, the first groove 612, and the second groove 610. The first mold core 620 and the groove sidewall of the first groove 611 form a first molding cavity for molding a first residue 300. The first mold core 620 and the groove sidewall of the second groove 612 form a second molding cavity for molding the body structure 110. The gap forming structure is a protruding block 614 disposed in the second molding cavity. Specifically, the protruding block 614 is disposed on the groove bottom wall of the second groove 612. The first upper stamping 630 is used for applying pressure on a powder in the first molding cavity and a powder in the second molding cavity to mold a body blank by compressing.

As shown in FIG. 15, the boss mold 700 includes a second lower stamping 710, a second mold core 720, and a second upper stamping 730. The end surface of one end of the second lower stamping 710 is provided with a third groove 711. Specifically, the end surface of the second lower stamping 710 facing the second upper stamping 730 is provided with a third groove 711. The groove bottom of the third groove 711 is provided with a fourth groove 712. The groove bottom of the fourth groove 712 is provided with a second through hole extending to the end surface of the other end of the second lower stamping 710. The second mold core 720 is inserted through the second through hole, the third groove 711, and the fourth groove 712. The second mold core 720 and the groove sidewall of the third groove 711 form a third molding cavity for molding a second residue 400. The second mold core 720 and the groove sidewall of the fourth groove 712 form a fourth molding cavity for molding the boss structure 120. The second upper stamping 730 is used for applying pressure to a powder in the third molding cavity and a powder in the fourth molding cavity to mold a boss blank by compressing.

In the ferrite molding process and the ferrite molding mold provided by this embodiment, the body blank is first formed by compressing through the body mold 600, the boss blank is formed by compressing through the boss mold 700, the body blank and the boss blank are sintered respectively to obtain the sintered body blank and the sintered boss blank, the sintered body blank and the sintered boss blank are ground to remove the first residue 300 and the second residue to obtain the body structure 110 and the boss structure 120, and the body structure 110 and the boss structure 120 are directly assembled. Therefore, a large number of breakages caused by the gap forming step are avoided, the yield of the ferrite 100 is improved, the ferrite molding process and the ferrite molding mold are applicable to the manufacturing of ferrites 100 of different shapes, and the investment in gap forming equipment is reduced.

### Embodiment Three

This embodiment provides a ferrite 100. The ferrite 100 is manufactured by using the ferrite molding process and the ferrite molding mold described in Embodiment one and

### Embodiment two

Optionally, the ferrite 100 in this embodiment includes a body structure 110 and a boss structure 120, and the body structure 110 has a gap. In some embodiments, the body structure 110 and the boss structure 120 are integrally formed, and then the ferrite 100 is manufactured by using the ferrite molding process provided by Embodiment one. In some other embodiments, the body structure 110 and the boss structure 120 are connected in a connection manner such as bonding through an adhesive, and then the ferrite 100 is manufactured by using the ferrite molding process provided by Embodiment two.

It is to be noted that the preceding are only preferred embodiments of the present disclosure and technical principles used therein. It is to be understood by those skilled in the art that the present disclosure is not limited to the embodiments described herein. Those skilled in the art can make various apparent modifications, adaptations, and substitutions without departing from the scope of the present disclosure. Therefore, while the present disclosure is described in detail through the preceding embodiments, the present disclosure is not limited to the preceding embodiments and may include more other equivalent embodiments without departing from the concept of the present disclosure. The scope of the present disclosure is determined by the scope of the appended claims.

What is claimed is:

1. A ferrite molding process, comprising the following steps:
step S1: adding a powder to a molding mold, wherein the molding mold is provided with a gap forming structure, and the gap forming structure is used for forming a gap of a ferrite;
step S2: compressing the powder into a blank;
step S3: sintering the blank in a heating furnace to form a sintered blank; and
step S4: performing molding on the sintered blank to obtain the ferrite.

2. The ferrite molding process according to claim 1, wherein the ferrite comprises a body structure and a boss structure, and the body structure and the boss structure are integrally formed in one mold.

3. The ferrite molding process according to claim 1, wherein the ferrite comprises a body structure and a boss structure, and the body structure and the boss structure are formed separately in two molds.

4. The ferrite molding process according to claim 3, wherein
in the step S1, the powder is added to a body mold and a boss mold, wherein the body mold comprises the gap forming structure;
in the step S2, the powder is compressed in the body mold to form a body blank, and the powder is compressed in the boss mold to form a boss blank;
in the step S3, the body blank is sintered in the heating furnace to form a sintered body blank, and the boss blank is sintered in the heating furnace to form a sintered boss blank;
the sintered body blank comprises a first residue and the body structure which are integrated, the body structure has a gap, the sintered boss blank comprises a second residue and the boss structure which are integrated, and the step S4 comprises:
step S41: removing the first residue of the sintered body blank to obtain the body structure;
step S42: removing the second residue of the sintered boss blank to obtain the boss structure; and
step S43: connecting the boss structure and the body structure to obtain the ferrite.

5. The ferrite molding process according to claim 4, wherein in the step S41, the first residue of the sintered body blank is removed by grinding to obtain the body structure;
in the step S42, the second residue of the sintered boss blank is removed by grinding to obtain the boss structure.

6. The ferrite molding process according to claim 4, wherein the step S43 comprises the following steps:
step S431: coating the body structure with an adhesive; and
step S432: pressing the boss structure onto the adhesive to bond the boss structure to the body structure through the adhesive.

7. The ferrite molding process according to claim 4, wherein the first residue is in a ring shape, the body structure is in an open ring shape, an inner ring surface of the first residue is flush with an inner ring surface of the body structure, and a width of the first residue is greater than a width of the body structure.

8. The ferrite molding process according to claim 4, wherein before the step S43, the ferrite molding process further comprises:
performing tumble finishing on the body structure; and
performing tumble finishing on the boss structure.

9. The ferrite molding process according to claim 1, wherein the sintered blank comprises a top residue, a body structure, a boss structure, and a bottom residue which are integrated, and in the step S4, the top residue and the bottom residue are removed by grinding to obtain the ferrite.

10. A ferrite molding mold, applied to the ferrite molding process according to claim 1 and comprising a main molding mold, wherein the main molding mold is provided with a molding cavity for molding a blank and a gap forming structure for forming a gap of a ferrite.

11. The ferrite molding mold according to claim 10, wherein the sintered blank comprises a top residue, a body structure, a boss structure, and a bottom residue which are integrated, the main molding mold comprises a lower punch, a mold core, and an upper punch, an end surface of one end of the lower punch is provided with a first molding groove, a groove bottom of the first molding groove is provided with a second molding groove, a groove bottom of the second molding groove is provided with a core bore, and the mold core passes through the core bore, the first molding groove, and the second molding groove; and
the gap forming structure comprises a first protrusion disposed on a groove sidewall of the first molding groove and a second protrusion disposed on a groove bottom wall of the first molding groove, a bottom end of the upper punch is provided with a third protrusion that is capable of extending into the first molding groove and disposing opposite to the first protrusion, the molding cavity comprises a top molding cavity formed by the first protrusion, the second protrusion, the groove sidewall of the first molding groove and the mold core and a bottom molding cavity formed by a groove sidewall of the second molding groove and the mold core, the top molding cavity is used for molding the top residue and the body structure, and the bottom molding cavity is used for molding the boss structure and the bottom residue.

12. The ferrite molding mold according to claim 11, wherein two fourth protrusions are disposed on two ends of a top surface of the second protrusion respectively, and a height sum of one of the two fourth protrusions and the second protrusion is equal to a thickness of the body structure.

13. The ferrite molding mold according to claim 11, wherein the main molding mold comprises a body mold and a boss mold;
the body mold comprises a first lower stamping, a first mold core, and a first upper stamping, an end surface of one end of the first lower stamping is provided with a first groove, a groove bottom of the first groove is provided with a second groove, a groove bottom of the second groove is provided with a first through hole extending to an end surface of the other end of the first lower stamping, the first mold core is inserted through the first through hole, the first groove, and the second groove, the first mold core and a groove sidewall of the first groove form a first molding cavity for molding a first residue, the first mold core and a groove sidewall of the second groove form a second molding cavity for molding the body structure, the gap forming structure is a protruding block disposed in the second molding cavity, and the first upper stamping is used for applying pressure to a powder in the first molding cavity and a powder in the second molding cavity to mold a body blank by compressing; and
the boss mold comprises a second lower stamping, a second mold core, and a second upper stamping, an end surface of one end of the second lower stamping is provided with a third groove, a groove bottom of the third groove is provided with a fourth groove, a groove bottom of the fourth groove is provided with a second through hole extending to an end surface of the other end of the second lower stamping, the second mold core is inserted through the second through hole, the third groove, and the fourth groove, the second mold core and a groove sidewall of the third groove form a third molding cavity for molding a second residue, the second mold core and a groove sidewall of the fourth groove form a fourth molding cavity for molding the boss structure, and the second upper stamping is used for applying pressure to a powder in the third molding cavity and a powder in the fourth molding cavity to mold a boss blank by compressing.

14. A ferrite, manufactured by using the ferrite molding process according to claim 1.
